(19) United States
(12) Patent Application Publication
(10) Pub. No.: US 2021/0166931 A1
(43) Pub. Date: Jun. 3, 2021

(54) ANALYZING DEVICE

(71) Applicants: SHIMADZU CORPORATION, Kyoto-shi, Kyoto (JP); NATIONAL UNIVERSITY CORPORATION NAGOYA UNIVERSITY, Nagoya-shi, Aichi (JP)

(72) Inventors: Kazumi YOKOTA, Kyoto-shi (JP); Kei ZAITSU, Nagoya-shi (JP); Yumi HAYASHI, Nagoya-shi (JP); Tasuku MURATA, Kyoto-shi (JP)

(73) Assignees: SHIMADZU CORPORATION, Kyoto-shi, Kyoto (JP); NATIONAL UNIVERSITY CORPORATION NAGOYA UNIVERSITY, Nagoya-shi, Aichi (JP)

(21) Appl. No.: 16/616,539

(22) PCT Filed: May 31, 2017
(86) PCT No.: PCT/JP2017/020345

§ 371 Date: Nov. 25, 2019

(51) Int. Cl. H01J 49/16; H01J 49/02; H01J 49/14; H01J 49/04

(52) U.S. Cl. CPC H01J 49/165; H01J 49/0468; H01J 49/145; H01J 49/025

(57) ABSTRACT

A biological sample is placed on a sample stage (8). The sample stage (8) includes a tray (82), a heater (83), and a temperature sensor (84). On the tray (82), a placement surface (821) on which a biological sample is placed is formed. The heater (83) heats a surface of the tray (82) on an opposite side to the placement surface (821) side. The temperature sensor (84) is provided on an opposite side of the heater (83) to the tray (82) side. The tray (82) is attachable to and detachable from the heater (83).

### TECHNICAL FIELD

The present invention relates to an analyzing device that analyzes an analysis object collected from a biological sample.

### BACKGROUND ART

As an example of an analyzing device that analyzes a biological sample, a mass spectrometer that performs mass spectrometry using probe electrospray ionization (PESI) is known (see, for example, Patent Document 1 below). In this type of analyzing device, an analysis object (for example, a biological tissue) is collected from a biological sample to the tip of a probe as the tip of the probe is pierced into the biological sample. Then, when a high voltage is applied to the probe, a strong electric field acts on the analysis object attached to the tip of the probe, and the analysis object is ionized by the electrospray phenomenon. Mass spectrometry is performed on the ions generated as described above, so that mass spectrum data is obtained.

The mass spectrometer disclosed in Patent Document 1 is provided with a sample stage for placing a biological sample. When analysis is performed, the tip of the probe is pierced into a biological sample on the sample stage, so that the analysis object is collected from the biological sample. In such a conventional mass spectrometer for analyzing a biological sample, a heater or the like for heating the biological sample is not provided on the sample stage. This is because in a case where a biological sample is placed on the sample stage, dirt generated from the biological sample adheres to a placement surface of the sample stage, and thus the placement surface needs to be cleaned. That is, in a case where the sample stage is provided with a heater, the sample stage needs to be removed together with the heater and the entire sample stage needs to be cleaned. For this reason, chemical resistance and airtightness need to be secured, and handling is not easy.

On the other hand, when analysis of a biological sample is performed, the biological sample may need to be heated. For example, when anesthesia is administered to a biological sample in an alive state, the temperature (body temperature) of the biological sample will be lower than the original temperature. However, there is a case where analysis needs to be performed while the normal temperature of the biological sample is maintained. In such a case, in the analysis using the conventional mass spectrometer, operation of maintaining the temperature of a biological sample (for example, a mouse) at the body temperature of an operator by holding the biological sample by the operator's hand, and, in this state, piercing the tip of a probe into the biological sample is performed.

### PRIOR ART DOCUMENT

### Patent Document

Patent Document 1: Japanese Patent Laid-Open No. 2014-44110

### SUMMARY OF THE INVENTION

### Problems to be Solved by the Invention

However, the conventional operation as described above is complicated and the positioning accuracy of the biological sample with respect to the probe is low. For this reason, there is a problem that the reproducibility when positioning the biological sample with respect to the probe is low, and collected amounts of an analysis object with respect to the tip of the probe tend to vary. Such a problem may occur not only in a mass spectrometer that analyzes a biological sample using PESI but also in other analyzing devices.

The present invention has been made in view of the above circumstances, and an object of the present invention is to provide an analyzing device capable of heating a biological sample and allows a placing surface of a sample stage to be cleaned easily.

### Means for Solving the Problems

(1) An analyzing device according to the present invention includes a sample stage and an analysis unit. A biological sample is placed on the sample stage. The analysis unit analyzes an analysis object collected from a biological sample placed on the sample stage. The sample stage includes a tray, a heater, and a temperature sensor. A placing surface on which a biological sample is placed is formed on the tray. The heater heats a surface of the tray opposite to the placing surface side. The temperature sensor is provided on the opposite side of the heater to the tray side. The tray is attachable to and detachable from the heater.

According to such a configuration, since the sample stage is provided with the heater, a biological sample placed on the placement surface on the tray can be heated by heating the tray using the heater. Further, since the tray is attachable to and detachable from the heater, the placement surface can be easily cleaned by removing only the tray from the sample stage.

Since the temperature sensor is provided on the opposite side of the heater to the tray side, only the tray can be removed from the heater while the temperature sensor is left on the heater side. Therefore, when the tray is removed from the heater, not only the heater but also the temperature sensor can be separated from the tray, so that only the tray to which no electrical component is attached can be easily cleaned.

(2) A thermal resistance from the heater to the placement surface of the tray and a thermal resistance from the heater to a detection surface of the temperature sensor may be set so that a temperature difference between a temperature of the placement surface of the tray and a temperature detected by the temperature sensor is within an allowable range.

According to such a configuration, even in a configuration where the temperature sensor is provided on the opposite side of the heater to the tray side, the temperature detected by the detection surface of the temperature sensor is within an allowable range with respect to the temperature of the placement surface of the tray. Therefore, drive of the heater is controlled based on the temperature detected by the temperature sensor, so that the biological sample placed on the placement surface can be accurately heated.

(3) The sample stage may include a triaxial displacement mechanism that can be displaced along two axes in a horizontal direction and one axis in a vertical direction.

According to such a configuration, the biological sample can be positioned in the horizontal direction by displacing the sample stage along two axes in the horizontal direction, and also the biological sample can be positioned in the vertical direction by displacing the sample stage along one axis in the vertical direction. Therefore, in the sample stage that can accurately position the biological sample in the horizontal direction and the vertical direction, the biological sample on the tray can be heated using the heater, and also the placement surface can be easily cleaned by removing only the tray from the sample stage.

(4) The temperature sensor may be provided in a region within a predetermined temperature range with respect to a position where a temperature in the heater is maximum.

According to such a configuration, the temperature sensor detects a temperature within a predetermined temperature range with respect to the maximum value of the temperature of the heater. By controlling the drive of the heater based on the temperature detected by the temperature sensor as described above, the temperature of the biological sample can be prevented from becoming too high.

(5) The analysis unit may be a mass spectrometry unit that performs mass spectrometry on an analysis object collected from a biological sample placed on the sample stage.

According to such a configuration, in the mass spectrometer that analyzes an analysis object collected from a biological sample in the mass spectrometry unit, the biological sample on the tray can be heated using the heater, and the placement surface can be easily cleaned by removing only the tray from the sample stage.

### Effects of the Invention

According to the present invention, a biological sample placed on the placement surface on the tray can be heated as the tray is heated using the heater provided on the sample stage. Further, according to the present invention, the placement surface can be easily cleaned by removing only the tray from the sample stage.

### BRIEF DESCRIPTION OF THE DRAWINGS

FIG. 1 is a schematic diagram showing a configuration example of an analyzing device according to an embodiment of the present invention.

FIG. 2 is a schematic cross-sectional view showing a configuration example of a sample stage.

FIG. 3 is a schematic cross-sectional view more specifically showing a configuration of the sample stage.

FIG. 4 is a schematic plan view of a heater.

### MODE FOR CARRYING OUT THE INVENTION

1. Configuration of Analyzing Device

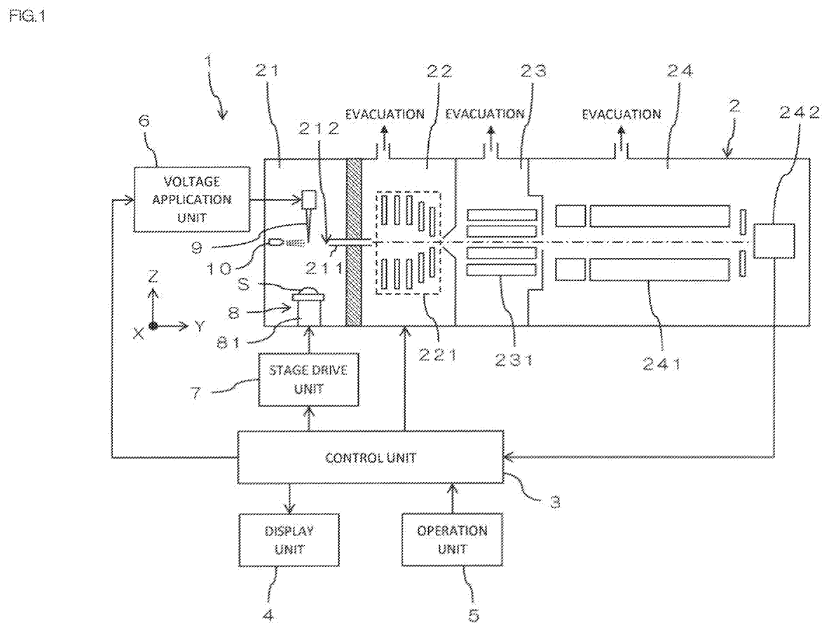

FIG. 1 is a schematic diagram showing a configuration example of an analyzing device 1 according to an embodiment of the present invention. The analyzing device 1 is a device for analyzing an analysis object such as a biological tissue collected from a biological sample S. In the present embodiment, a case where the analyzing device 1 is a mass spectrometer that performs mass spectrometry on an analysis object will be described.

The biological sample S may be an animal, such as a mouse, itself or part of an animal body. For example, in a case where an animal itself is used as the biological sample S, anesthesia is administered to the biological sample S while the biological sample S is alive, and the biological sample S in an unmoving state is set in the analyzing device 1. In the analyzing device 1 according to the present embodiment, the biological sample S that is set can be heated to perform analysis in a state where the biological sample S is maintained at a predetermined temperature (for example, the original body temperature of the biological sample S). However, the biological sample S is not limited to an animal, such as a mouse, but may be a tissue piece or blood.

The analyzing device 1 includes a mass spectrometry unit 2, a control unit 3, a display unit 4, an operation unit 5, a voltage application unit 6, a stage drive unit 7, and the like. In the mass spectrometry unit 2, an ionization chamber 21, a first vacuum chamber 22, a second vacuum chamber 23, and an analysis chamber 24 are formed. The ionization chamber 21, the first vacuum chamber 22, the second vacuum chamber 23, and the analysis chamber 24 are formed in a line in this order, and adjacent chambers communicate with each other.

The biological sample S is placed on a sample stage 8 provided in the ionization chamber 21. In the present embodiment, the mass spectrometry unit 2 uses the probe electrospray ionization (PESI) to perform mass spectrometry for an analysis object collected from the biological sample S placed on the sample stage 8.

Specifically, a probe 9 provided in the ionization chamber 21 is pierced into the biological sample S on the sample stage 8, so that an analysis object (for example, a biological tissue) is collected from the biological sample S to the tip of the probe 9. As a high voltage (for example, about several kV at the maximum) is applied from the voltage application unit 6 to the probe 9, a strong electric field acts on the analysis object attached to the tip of the probe 9, and the analysis object is ionized by the electrospray phenomenon.

At this time, a solvent is sprayed from a nozzle 10 to the tip of the probe 9. The solvent is, for example, water, alcohols, acetonitrile, or the like, and is sprayed as fine droplets by the nozzle 10. The spraying of the solvent from the nozzle 10 is not essential. However, there are advantages that, by spraying the solvent onto the analysis object, the analysis object can be prevented from being dried and the electrospray can be performed in an excellent manner.

However, the solvent can be attached to the tip of the probe 9 using any solvent supply unit other than the nozzle 10. For example, a container containing the solvent inside may be installed on the biological sample S as the solvent supply unit. Specifically, the configuration may be such that, when moving down, the probe 9 passes through the solvent in the container, so that the solvent is attached to the tip of the probe 9, and, as the probe 9 moves down further, the tip of the probe 9 to which the solvent is attached is pierced into the biological sample S. In this case, when the probe 9 after the tip is pierced into the biological sample S moves up, the tip of the probe 9 passes through the solvent in the container again, so that the analysis object collected at the tip is enveloped by the solvent.

The ionization chamber 21 communicates with the first vacuum chamber 22 via an ion introduction tube 211 extending in a straight line. Ions generated from the analysis object are sucked into the ion introduction tube 211 due to a pressure difference between the ionization chamber 21 and the first vacuum chamber 22, and are guided into the first vacuum chamber 22 through the ion introduction tube 211. An ion guide 221 is provided in the first vacuum chamber 22, and ions flowing into the first vacuum chamber 22 are converged by the ion guide 221 and guided into the second vacuum chamber 23. An ion guide 231 is provided in the second vacuum chamber 23, and ions flowing into the second vacuum chamber 23 are converged by the ion guide 231 and guided into the analysis chamber 24.

In the analysis chamber 24, a quadrupole mass filter 241 is provided. That is, the analyzing device 1 in the present embodiment is a quadrupole mass spectrometer. A predetermined voltage is applied to four rod electrodes constituting the quadrupole mass filter 241, and only ions having a mass-to-charge ratio corresponding to the voltage pass through the quadrupole mass filter 241. Ions that pass through the quadrupole mass filter 241 are detected by a detector 242 provided in the analysis chamber 24, and the detector 242 outputs a detection signal corresponding to an amount of the detected ions. Therefore, for example, if a voltage applied to the four rod electrodes constituting the quadrupole mass filter 241 is scanned within a predetermined range, a mass-to-charge ratio of ions that can pass through the quadrupole mass filter 241 is scanned.

The control unit 3 is configured, for example, by a computer, and controls the operation of the mass spectrometry unit 2 and processes data input from the mass spectrometry unit 2. By the processing of the control unit 3, mass spectrum data is obtained based on the detection signal from the detector 242. The display unit 4 is configured, for example, by a liquid crystal display and displays various pieces of information, such as an analysis result, under the control of the control unit 3. The operation unit 5 is configured, for example, with a keyboard, a mouse, and the like, and the operator can input various pieces of information, such as an analysis condition, to the control unit 3 by operating the operation unit 5. The voltage applied from the voltage application unit 6 to the probe 9 is controlled by the control unit 3.

In the present embodiment, the sample stage 8 is provided with a triaxial displacement mechanism 81. The triaxial displacement mechanism 81 can be displaced along X, Y, and Z axes. The X axis and the Y axis are two axes in a horizontal direction and are orthogonal to each other. Further, the Z axis is one axis in a vertical direction, and is orthogonal to the X axis and the Y axis. The triaxial displacement mechanism 81 is driven by a stage drive unit 7 including, for example, a motor.

The probe 9 extends in the vertical direction, and is disposed above the sample stage 8 with a gap between them in a manner that the tip of the probe 9 faces downward. The biological sample S placed on the sample stage 8 is positioned in the horizontal direction with respect to the probe 9 by the displacement along the X axis and the Y axis of the triaxial displacement mechanism 81, and is positioned in the vertical direction with respect to the probe 9 by displacement along the Z axis of the triaxial displacement mechanism 81. The control unit 3 can pierce the probe 9 at a preset position with respect to the biological sample S on the sample stage 8 by controlling the drive of the stage drive unit 7.

2. Configuration of Sample Stage

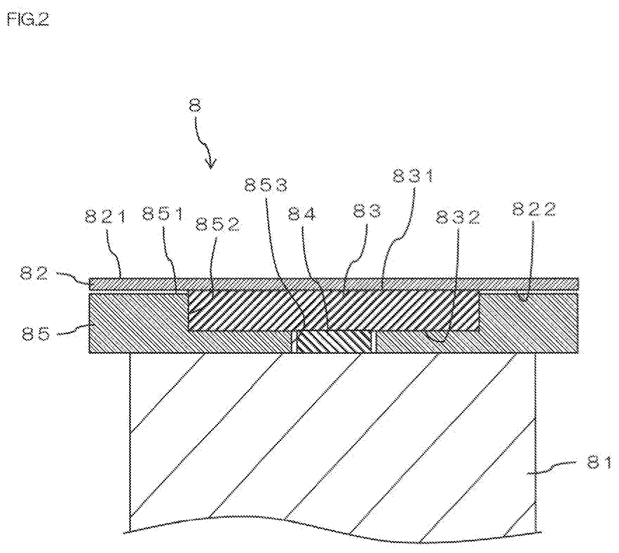

FIG. 2 is a schematic cross-sectional view showing a configuration example of the sample stage 8. The sample stage 8 includes a tray 82 on which the biological sample S is placed, a heater 83 that heats the tray 82, a temperature sensor 84 that detects the temperature of the tray 82, and a heater holding block 85 that holds the heater 83.

The tray 82 is a plate-like member made from, for example, stainless steel. The tray 82 is disposed so as to extend in the horizontal direction, and an upper surface of the tray 82 constitutes a placement surface 821 for placing the biological sample S. The material of the tray 82 is not limited to stainless steel, and the tray 82 can be formed of other various materials. However, the placement surface 821 of the tray 82 is preferably made from a material having high chemical resistance and corrosion resistance because dirt generated from the biological sample S may be attached and need to be cleaned.

The heater 83 abuts on a lower surface 822 of the tray 82, that is, a surface opposite to the placement surface 821, and heats the lower surface 822. The heater 83 has a plate shape and is arranged to extend in the horizontal direction. An upper surface 831 of the heater 83 is a flat surface extending in the horizontal direction, and the tray 82 is placed on the upper surface 831 of the heater 83. By heating the tray 82 with the heater 83, the biological sample S placed on the placement surface 821 of the tray 82 can be heated.

As described above, the tray 82 is attached to the heater 83 by being placed on the upper surface 831 of the heater 83. That is, the tray 82 is detachably attached to the heater 83 by its own weight. However, the configuration of the tray 82 is not limited to one in which the tray 82 is merely placed on the upper surface 831 of the heater 83, and the tray 82 may be attached to the heater 83 using a fixing tool, such as a bolt or a pin. That is, the tray 82 only needs to be attachable to and detachable from the heater 83, and the attachment mode of the tray 82 is optional.

The temperature sensor 84 is attached to a lower surface 832 of the heater 83, that is, a surface opposite to the tray 82 side. As described above, the temperature sensor 84 is separated from the tray 82 by being provided on the side of the heater 83 opposite to the tray 82 side. The temperature sensor 84 can detect a temperature of the tray 82 by detecting heat from the heater 83.

The heater holding block 85 is a plate-like member made from, for example, stainless steel. The material of the heater holding block 85 is not limited to stainless steel, and the heater holding block 85 can be formed of other various materials. However, the heater holding block 85 is preferably formed of a material having thermal properties close to those of the tray 82.

The heater holding block 85 is disposed so as to extend in the horizontal direction, and a recess 852 for accommodating and holding the heater 83 is formed on an upper surface 851 of the heater holding block 85. The depth of the recess 852 is slightly smaller than the thickness of the heater 83. Therefore, the heater 83 is held in a state where the upper surface 831 of the heater 83 protrudes from the upper surface 851 of the heater holding block 85.

Further, an opening 853 that penetrates the heater holding block 85 is formed in part of a bottom surface of the recess 852. In a state where the heater 83 is held in the recess 852, the temperature sensor 84 attached to the lower surface 832 of the heater 83 is accommodated in the opening 853.

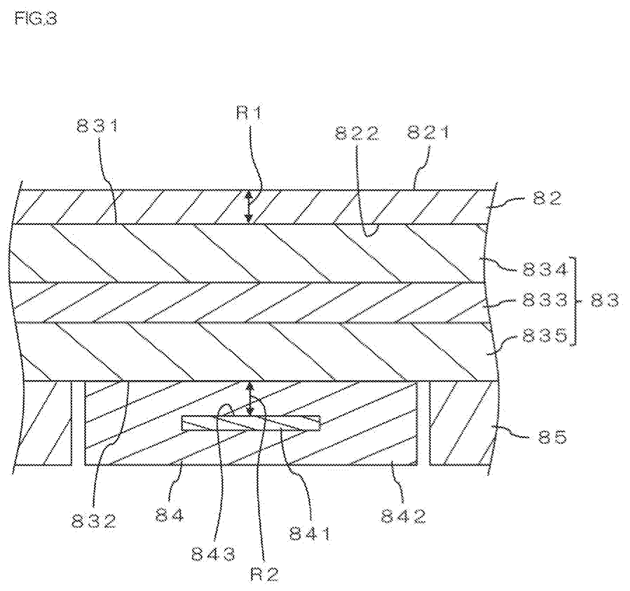

FIG. 3 is a schematic cross-sectional view more specifically showing a configuration of the sample stage 8. In the present embodiment, the heater 83 is configured with a rubber heater. Specifically, the heater 83 has a laminated structure including a heater layer 833 provided with a heater wire that generates heat when energized, and a pair of rubber layers 834 and 835 made from rubber sandwiching the heater layer 833 vertically. An upper surface of the upper rubber layer 834 constitutes the upper surface 831 of the heater 83, and a lower surface of the lower rubber layer 835 constitutes the lower surface 832 of the heater 83. However, the heater 83 is not limited to a rubber heater, and may be another heater, such as a ceramic heater.

The temperature sensor 84 includes a sensor main body 841 and a covering member 842 that covers the sensor main body 841. That is, the temperature sensor 84 has a configuration in which the sensor main body 841 is enclosed in the covering member 842. The covering member 842 is made from, for example, stainless steel. The material of the covering member 842 is not limited to stainless steel, and the covering member 842 can be formed of other various materials. However, the covering member 842 is preferably formed of a material having thermal properties close to those of the tray 82. Further, the sensor main body 841 is not limited to the configuration in which the sensor main body 841 is enclosed in the covering member 842, and at least part of the sensor main body 841 may be exposed.

The sensor main body 841 has, for example, a sensor element, such as a thermocouple, and an upper surface close to the heater 83 constitutes a detection surface 843. The control unit 3 can control the temperature of the tray 82 (the placement surface 821) by controlling an energization amount for the heater 83 (heater wire) based on the temperature detected by the detection surface 843 of the temperature sensor 84. In a case where the biological sample S is placed on the placement surface 821 as in the present embodiment, the temperature of the placement surface 821 is controlled to be, for example, an enzyme activation temperature (about 37° C.).

In the present embodiment, a thermal resistance R1 from the heater 83 to the placement surface 821 of the tray 82 and a thermal resistance R2 from the heater 83 to the detection surface 843 of the temperature sensor 84 are set to be the same or approximate values. More specifically, the thermal resistances R1 and R2 are set so that a temperature difference between a temperature of the placement surface 821 of the tray 82 and a temperature detected by the detection surface 843 of the temperature sensor 84 is within an allowable range. The allowable range is, for example, 0° C. to 2° C., more preferably about 1° C. However, the allowable range is not limited to this value.

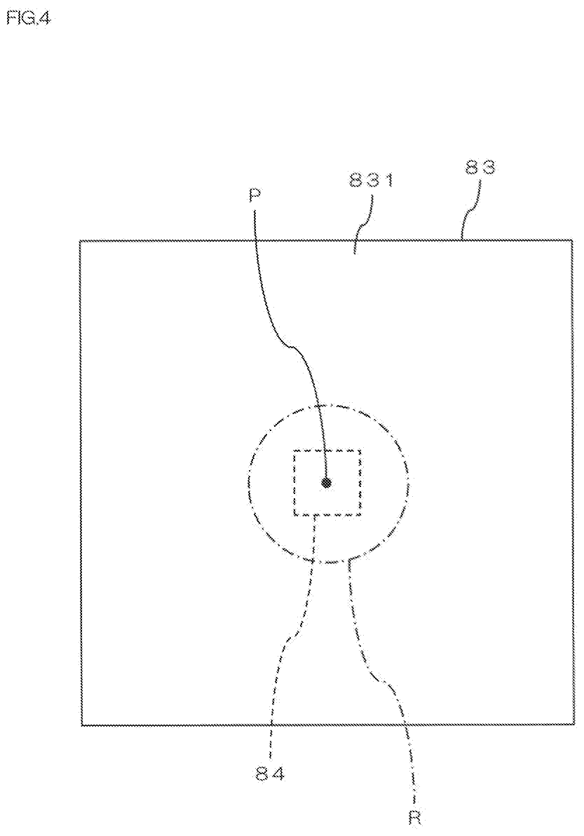

FIG. 4 is a schematic plan view of the heater 83. For example, the heater 83 is formed in a rectangular shape in plan view. In this example, the heater 83 is formed in a square shape in plan view. However, the heater 83 may be formed in another rectangular shape, or may be formed in another shape, such as a circular shape or an elliptical shape.

The temperature sensor 84 is disposed in the vicinity of a position P where the temperature in the heater 83 is maximum. Specifically, the temperature sensor 84 is provided in a region R within a predetermined temperature range with respect to the position P The predetermined temperature range is preferably, for example, a range of ±5° C. However, the predetermined temperature range is not limited to this value. Note that the position P is not necessarily a center position of the heater 83.

3. Action and Effect

(1) In the present embodiment, the sample stage 8 is provided with the heater 83. For this reason, the biological sample S placed on the placement surface 821 on the tray 82 can be heated as the tray 82 using the heater 83 is heated. Further, since the tray 82 is attachable to and detachable from the heater 83, the placement surface 821 can be easily cleaned by removing only the tray 82 from the sample stage 8.

Since the temperature sensor 84 is provided on the opposite side of the heater 83 to the tray 82 side, only the tray 82 can be removed from the heater 83 while the temperature sensor 84 is left on the heater 83 side. Therefore, when the tray 82 is removed from the heater 83, not only the heater 83 but also the temperature sensor 84 can be separated from the tray 82, so that only the tray 82 to which no electrical component is attached can be easily cleaned.

(2) In particular, in the present embodiment, the thermal resistance R1 from the heater 83 to the placement surface 821 of the tray 82 and the thermal resistance R2 from the heater 83 to the detection surface 843 of the temperature sensor 84 are set to be appropriate. In this manner, even in a configuration where the temperature sensor 84 is provided on the opposite side of the heater 83 to the tray 82 side, the temperature detected by the detection surface 843 of the temperature sensor 84 is within an allowable range with respect to the temperature of the placement surface 821 of the tray 82. Therefore, drive of the heater 83 is controlled based on the temperature detected by the temperature sensor 84, so that the biological sample S placed on the placement surface 821 can be accurately heated.

(3) Further, in the present embodiment, the biological sample S can be positioned in the horizontal direction by displacing the sample stage 8 along two axes (X axis and Y axis) in the horizontal direction by using the triaxial displacement mechanism 81, and also the biological sample S can be positioned in the vertical direction by displacing the sample stage 8 along one axis (Z axis) in the vertical direction. Therefore, in the sample stage 8 that can accurately position the biological sample S in the horizontal direction and the vertical direction, the biological sample S on the tray 82 can be heated using the heater 83, and also the placement surface 821 can be easily cleaned by removing only the tray 82 from the sample stage 8.

(4) Furthermore, in the present embodiment, the position of the temperature sensor 84 with respect to the heater 83 is appropriately set. In this manner, the temperature sensor 84 detects a temperature within a predetermined temperature range with respect to the maximum value of the temperature of the heater 83. By controlling the drive of the heater 83 based on the temperature detected by the temperature sensor 84 as described above, the temperature of the biological sample S can be prevented from becoming too high.

4. Variation

In the above embodiment, a case where the analyzing device 1 is a mass spectrometer that analyzes the biological sample S using PESI is described. However, the analyzing device may be a mass spectrometer that analyzes the biological sample S by a method other than PESI. Further, the configuration of the mass spectrometry unit 2 is not limited to the configuration as in the above embodiment. Furthermore, the present invention is not limited to a mass spectrometer, and can be applied to other various analyzing devices that analyze an analysis object collected from the biological sample S.

### DESCRIPTION OF REFERENCE SIGNS

1 analyzing device
2 mass spectrometry unit
3 control unit
4 display unit
5 operation unit
6 voltage application unit
7 stage drive unit
8 sample stage
9 probe
10 nozzle
81 triaxial displacement mechanism
82 tray
83 heater
84 temperature sensor
85 heater holding block
821 placement surface
843 detection surface

1. An analyzing device comprising:
a sample stage on which a biological sample is placed; and
an analysis unit that analyzes an analysis object collected from a biological sample placed on the sample stage, wherein
the sample stage includes a tray on which a placement surface on which a biological sample is placed is formed, a heater that heats a surface of the tray on an opposite side to the placement surface side, and a temperature sensor provided on an opposite side of the heater to the tray side, and
the tray is attachable to and detachable from the heater at a position facing to the temperature sensor,
the analysis unit is a mass spectrometry unit that performs mass spectrometry on an analysis object collected from a biological sample placed on the sample stage using a probe electrospray ionization.

2. The analyzing device according to claim 1, wherein a thermal resistance from the heater to the placement surface of the tray and a thermal resistance from the heater to a detection surface of the temperature sensor are set so that a temperature difference between a temperature of the placement surface of the tray and a temperature detected by the temperature sensor is within an allowable range.

3. The analyzing device according to claim 1, wherein the sample stage includes a triaxial displacement mechanism that can be displaced along two axes in a horizontal direction and one axis in a vertical direction.

4. The analyzing device according to claim 1, wherein the temperature sensor is provided in a region within a predetermined temperature range with respect to a position where a temperature in the heater is maximum.

5. (canceled)
